(19) United States
(12) Patent Application Publication
(10) Pub. No.: US 2013/0318322 A1
(43) Pub. Date: Nov. 28, 2013

(54) Memory Management Scheme and Apparatus

(71) Applicants: Varun Shetty, Bangalore (IN); Dipankar Das, Bangalore (IN); Debjit Roy Choudhury, West Bengal (IN); Ashank Reddy, Bangalore (IN)

(72) Inventors: Varun Shetty, Bangalore (IN); Dipankar Das, Bangalore (IN); Debjit Roy Choudhury, West Bengal (IN); Ashank Reddy, Bangalore (IN)

(73) Assignee: LSI CORPORATION, Milpitas, CA (US)

(21) Appl. No.: 13/481,903

(22) Filed: May 28, 2012

(51) Int. Cl. G06F 12/06

(52) U.S. Cl. 711/172; 711/E12.078

(57) ABSTRACT

A memory management apparatus includes a first controller adapted to receive an input data sequence including one or more data frames and operative: to separate each of the data frames into a payload data portion and a header portion; to store the payload data portion in at least one available memory location in a physical storage space; and to store in a logical storage space the header portion along with at least one associated index indicating where in the physical storage space the corresponding payload data portion resides. The apparatus further includes a second controller operative, as a function of a data read request, to access the physical storage space using the header portion and associated index from the logical storage space to retrieve the corresponding payload data portion and to combine the header portion with the payload data portion to generate a response to the data read request.

### BACKGROUND

Memory management encompasses the act of controlling the utilization of physical memory resources in a system, such as, for example, a computer system. An essential requirement of memory management is to provide a mechanism for dynamically allocating portions (e.g., blocks) of memory to one or more applications running on the system at their request, and releasing such memory for reuse when no longer needed. This function is critical to the computer system.

Unfortunately, when blocks of memory are allocated during runtime, it is highly unlikely that these released blocks of memory will again form continuous large memory blocks. Consequently, free memory gets interspersed with blocks of memory in use; the average size of contiguous blocks of memory available for allocation therefore becomes quite small. Frequent deletion and creation of volumes only increases the amount of non-contiguous memory in a system. This problem, coupled with incomplete usage of the allocated memory, results in what is commonly referred to as memory fragmentation, which is undesirable.

### SUMMARY

Principles of the invention, in illustrative embodiments thereof, provide a memory management apparatus and methodology which advantageously enhance the efficiency of memory allocation in a system. By utilizing a paging mechanism to store only payload data in physical memory and by storing headers and corresponding pointers to the associated payload data in a logical storage area, embodiments of the invention permit the physical address space of a volume requirement to be non-contiguously stored, thereby essentially eliminating the problem of memory fragmentation.

In accordance with an embodiment of the invention, a memory management apparatus includes first and second controllers. The first controller is adapted to receive an input data sequence including one or more data frames and is operative: (i) to separate each of the data frames into a payload data portion and a header portion corresponding thereto; (ii) to store the payload data portion in at least one available memory location in a physical storage space; and (iii) to store in a logical storage space the header portion along with at least one associated index indicative of where in the physical storage space the corresponding payload data portion resides. The second controller is operative, as a function of a data read request, to access the physical storage space using the header portion and the associated index from the logical storage space to retrieve the corresponding payload data portion and to combine the header portion with the payload data portion to generate a response to the data read request.

In accordance with another embodiment of the invention, a method of controlling the utilization of physical memory resources in a system includes the steps of: receiving an input data sequence comprising one or more data frames; separating each of the one or more data frames in the input data sequence into a payload data portion and a header portion corresponding thereto; storing the payload data portion in at least one available memory location in a physical storage space; and storing in a logical storage space the header portion along with at least one associated index indicative of where in the physical storage space the corresponding payload data portion resides.

In accordance with yet another embodiment of the invention, an electronic system includes physical memory and at least one memory management module coupled with the physical memory. The memory management module includes first and second controllers. The first controller is adapted to receive an input data sequence including one or more data frames and is operative: (i) to separate each of the data frames into a payload data portion and a header portion corresponding thereto; (ii) to store the payload data portion in at least one available memory location in the physical memory; and (iii) to store in a logical storage space the header portion along with at least one associated index indicative of where in the physical memory the corresponding payload data portion resides. The second controller is operative, as a function of a data read request, to access the physical memory using the header portion and the associated index from the logical storage space to retrieve the corresponding payload data portion and to combine the header portion with the payload data portion to generate a response to the data read request.

Embodiments of the present invention will become apparent from the following detailed description thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 conceptually depicts an exemplary physical memory having 100 GB of available free physical storage space formed using four separate 25 GB hard disk drives, along with four logical volumes of 10 GB each;

FIG. 2A conceptually depicts an exemplary mapping of the four logical volumes shown in FIG. 1 with the physical memory;

FIG. 2B conceptually depicts deletion of one of the logical volumes in the exemplary mapping shown in FIG. 2A, according to a conventional memory allocation scheme;

FIG. 3 is a conceptual diagram depicting at least a portion of an exemplary memory management scheme, according to an embodiment of the invention;

FIG. 4 is a flow diagram depicting at least a portion of an exemplary memory management method, according to an embodiment of the invention;

FIG. 5A conceptually depicts a physical storage space which is divided into a plurality of frames, according to an embodiment of the invention;

FIG. 5B conceptually depicts a logical storage space (i.e., logical volume) which is divided into a plurality of pages, according to an embodiment of the invention;

FIG. 6 conceptually depicts an exemplary mapping of pages of a logical storage space to frames of a physical storage space, according to an embodiment of the invention;

FIG. 7 is a block diagram depicting at least a portion of an exemplary memory management system 700 which conceptually illustrates a paging mechanism suitable for use with embodiments of the invention;

FIGS. 8 and 9A-9C conceptually illustrate an exemplary mechanism to overcome fragmentation, according to an embodiment of the invention; and

FIG. 10 is a block diagram depicting at least a portion of an exemplary processing system formed in accordance with an embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Embodiments of the invention will be described herein in the context of an illustrative non-contiguous memory allocation scheme which advantageously separates header and payload data and stores only the payload data in the physical medium while storing the header data, along with corresponding pointers to the multiple segments of the payload data, in a logical storage area. In this manner, embodiments of the invention permit the physical address space of a volume to be non-contiguous, thereby eliminating memory fragmentation problems in the system. It should be understood, however, that the present invention is not limited to these or any other particular methods, apparatus and/or system arrangements. Rather, the invention is more generally applicable to techniques for improving memory management efficiency in a system. As will become apparent to those skilled in the art given the teachings herein, numerous modifications can be made to the embodiments shown that are within the scope of the claimed invention. That is, no limitations with respect to the embodiments described herein are intended or should be inferred.

As previously stated, when blocks of memory are allocated during runtime, it is highly unlikely that these released blocks of memory will be combined again form continuous large memory blocks. Consequently, free memory gets interspersed with blocks of memory in use, thereby increasing memory fragmentation and reducing the average size of contiguous memory blocks available for allocation.

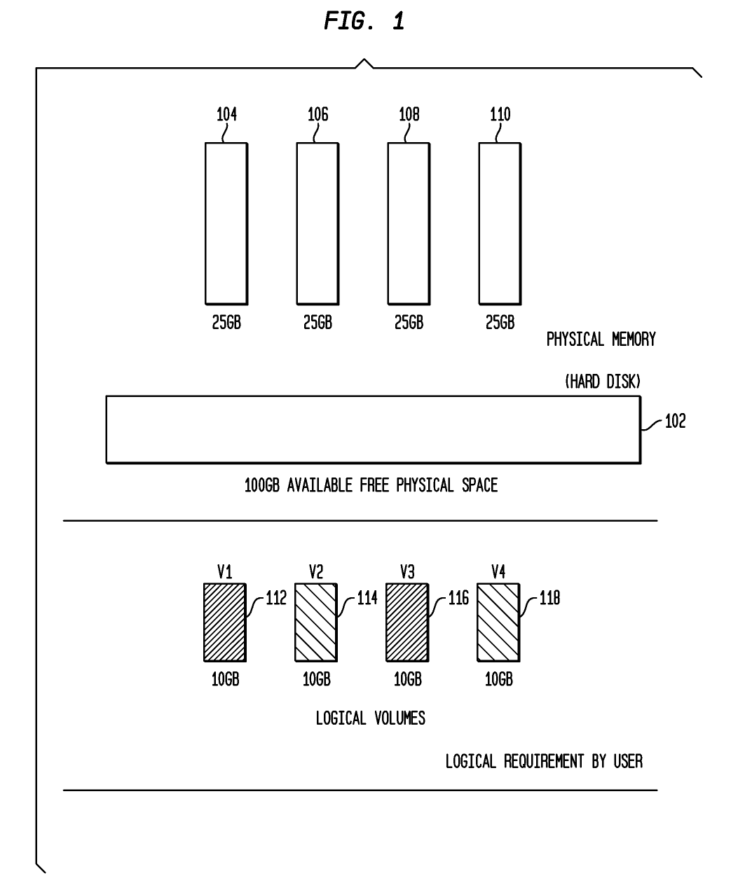

A standard memory management approach utilizes a contiguous allocation of logical volume requirement to physical memory. Consider, for example, a scenario in which four hard disk drives, each having a storage capacity of 25 gigabytes (GB), is used to create a redundant array of independent disks (RAID) volume group (VG). FIG. 1 conceptually illustrates a physical memory 102 having 100 GB of available free physical storage space formed using four separate 25 GB hard disk drives 104, 106, 108 and 110. Furthermore, assume that a user creates four logical volumes, V1 112, V2 114, V3 116 and V4 118, of 10 GB each.

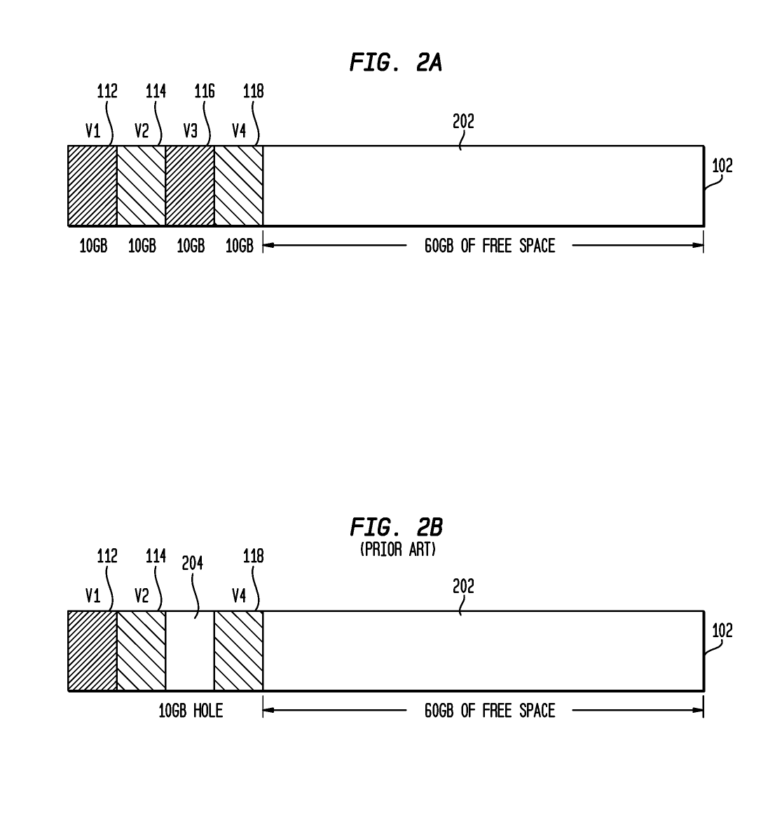

At runtime, the four user-required volumes 112, 114, 116 and 118 are allocated contiguously in the physical memory 102. FIG. 2A conceptually illustrates how logical volumes 112, 114, 116 and 118 are mapped with the physical memory 102. This leaves 60 GB of free space 202 in the physical memory 102. Now consider the deletion of logical volume V3 116. FIG. 2B conceptually illustrates the deletion of volume V3 116 from the physical memory 102 according to a standard memory allocation scheme. As apparent from FIG. 2B, the deletion of volume V3 116 creates a 10 GB “hole” 204 in the physical memory 102. The total amount of free space will be 70 GB, although such free space is non-contiguous. Therefore, if the user tries to create a volume of size 65 GB using a standard contiguous memory allocation scheme, the volume creation operation will fail because of external fragmentation. Specifically, although 70 GB of free space is available in the physical memory 102, the largest volume creatable is only 60 GB, as this represents the largest contiguous free space available. Thus, due to external fragmentation resulting from, for example, frequent deletion and volume creation, the physical memory is not able to be efficiently used for logical volume creation. While defragmentation (i.e., compaction) can be used to increase the amount of contiguous free space available for volume creation, the defragmentation process would require significant time and additional resources to perform the required movement of volumes in a VG, which is disadvantageous.

Aspects of the invention address at least the above-noted problem by providing a memory management scheme which advantageously enhances the efficiency of memory allocation in a system. By utilizing a paging mechanism to store only payload data in physical memory and by storing headers and corresponding address pointers to the associated payload data in a logical storage area, embodiments of the invention permit the physical address space of a logical volume to be non-contiguous, thereby essentially eliminating the problem of memory fragmentation in the system. Moreover, by storing only payload data in the physical storage space and storing the corresponding header in a logical volume, the amount of data that needs to be moved is significantly less (i.e., the header can be moved amongst multiple levels and the payload data can remain untouched until processing of the payload data is required). This approach significantly reduces bus utilization as well, thereby improving overall efficiency of the system.

As an overview of an illustrative embodiment of the invention, the physical memory is divided into fixed-size blocks, referred to herein as frames. The logical volume requirement is also divided into a plurality of equal-size blocks, referred to herein as pages. When a volume is created, the pages forming the logical space are loaded into any available frames of the physical memory, even non-contiguous frames. To accomplish this, incoming data frames are analyzed, such as, for example, by a hardware and/or software mechanism, which may be referred to herein as a separation module; a header component and a payload data component forming each of the incoming data frames is identified. The header components of the respective incoming data frames are extracted and stored in a separate logical storage area along with address pointers to the associated payload data components. The payload data components are then stored in multiple physical memory locations, with the addresses of the multiple memory locations returned to the separation module as address pointers. Thus, the separation module is operative to receive the incoming data frames, to recognize the header and payload data components, and to separate the two components and store them in such a manner that pointers to the payload data are maintained. When the data needs to be read, the logical block is accessed to retrieve the header component of the associated payload data along with the corresponding pointers to the locations in which the payload data can be accessed.

By way of example only and without loss of generality, a methodology according to an embodiment of the invention utilizes an abstraction of an abstraction. More particularly, as an overview in accordance with an embodiment of the invention, there is an abstraction of the data when the header and the payload components are split so that payload data can be stored at various locations. The locations in which portions of the payload data are stored are, in turn, returned to a memory manager, or alternative first controller, in the form of frame numbers (i.e., a first level abstraction). Further, the frame numbers and the header information that has been collected by the memory manager are sent to a separation manager, or alternative second controller. Once the separation manager receives frame numbers associated with the headers, it sends only the headers to a logical storage space (i.e., a second level abstraction). The first level abstraction is when payload and the headers are split by a paging mechanism; the second level abstraction is when the separation manager sends only the header information to the logical storage space. Thus, according to an embodiment of the invention, the input data is analyzed to separate the respective headers and associated payload data. The payload data is saved on another logical volume; this payload data may be saved at multiple pages of this logical volume. The page numbers (e.g., addresses) in which the payload data are saved are communicated to the first logical volume through the separation module to be stored along with the headers as pointers to the payload data.

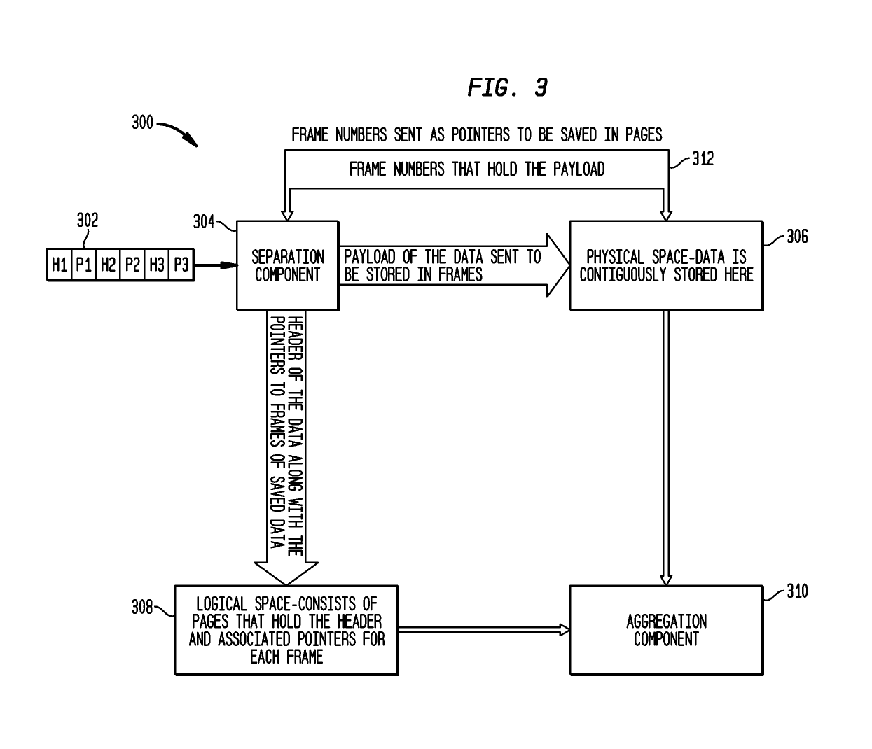

FIG. 3 is a diagram conceptually depicting at least a portion of an exemplary memory management system 300, according to an embodiment of the invention. The memory management system 300 is operative to receive an incoming data sequence 302 (e.g., a data stream) that is divided into one or more frames, with each frame comprising a header portion and a corresponding payload data portion. In the example shown, the incoming data sequence 302 comprises a first header portion, H1, and corresponding payload data portion, P1, forming a first frame, a second header portion, H2, and corresponding payload data portion, P2, forming a second frame, and a third header portion, H3, and corresponding payload data portion, P3, forming a third frame. It to be understood, however, that the embodiments of the invention are not limited to any specific number of header portions and corresponding payload data portions in the incoming data sequence 302. Nor is the specific format of the header and payload data critical to an operation according to embodiments of the invention.

The memory management system 300 includes a separation component or module 304, a physical memory 306, which may comprise, for example, random access memory (RAM), hard disk drive(s), or an alternative physical storage medium, a logical storage space 308, and an aggregation component or module 310. The separation module 304, or alternative first controller, is operative to receive the incoming data sequence 302 and to separate each frame of the data sequence into its header and corresponding payload data portions. More particularly, the separation module 304, which can be implemented in hardware, software or a combination of hardware and software, is operative to parse or otherwise analyze data that is input to the memory management system 300 and to separate the data into its respective components; namely, the header and payload data portions. Techniques for parsing data, or otherwise manipulating and/or extracting useful information from the data, that are suitable for use with embodiments of the invention will be known by those skilled in the art. Such techniques may include, for example, the recognition of frame boundaries and data formats within the incoming data stream.

The physical memory 306 is preferably divided into a plurality of fixed-size blocks or frames, as previously stated. Once the header components (e.g., H1, H2, H3) have been extracted (i.e., isolated) from their corresponding payload data components (e.g., P1, P2, P3, respectively), the separation module 304 sends the respective payload data components to the physical memory 306 for storage. The payload data components are stored in one or more frames of the physical memory 306 as a function of the size of the payload data being stored.

Specifically, according to an illustrative embodiment of the invention, the payload data is saved in the physical memory 306 after determining the available frames in the physical memory. This can be accomplished using a memory manager in the system 300 (not explicitly shown), or an alternative means for tracking free space in the physical memory 306. As will be understood by those skilled in the art, the memory manager according to an embodiment of the invention is an abstraction. For example, the memory manager can be a separate module in a controller or it can be part of the main memory management unit functionality as well. In an illustrative embodiment, the memory manager resides in the separation module 304, but the invention is not limited to this configuration.

The payload data may be split, using, for example, a paging mechanism or an alternative memory allocation means, and stored across multiple frames of the physical memory 306, based at least in part on information regarding the availability of frames in the physical memory and the size of the payload data being stored. The multiple frames in which the payload data may be stored need not be contiguous.

Frames numbers 312, or an alternative index (e.g., address pointers, etc.), corresponding to frames in the physical memory 306 in which the payload data portion of the incoming data sequence 302 is stored, are returned to the memory manager, which, in turn, is sent to the separation module 304. The separation module 304 holds the header component (e.g., H1) of the incoming data sequence 302, whose corresponding payload data portion (e.g., P1) has been transferred to the physical memory 306, until receiving the associated frame numbers indicative of the frames in the physical memory in which the payload data portion is stored. Once the separation module 304 has received the frame numbers, the separation module sends the header portion and associated frame numbers, in the form of pointers, to the logical storage space 308 to be stored on one or more pages of the logical volume.

When a data read request is received by the memory management system 300 indicating that the data corresponding to a given address needs to be read, the data request is passed to the aggregation module 310. The aggregation module 310, or alternative second controller, is operative to retrieve the header information stored on one or more pages of the logical storage volume 308 and the associated pointers for each frame. Using the retrieved header information and associated pointers from the logical storage volume 308, the aggregation module 310 is operative to access the physical memory 306 to retrieve the payload data and to combine the payload data with the corresponding header to be returned as a response to the data read request. Thus, in this illustrative embodiment, the header is accessed first, which thereby retrieves the pointers, which in turn point to corresponding locations in the physical memory 306.

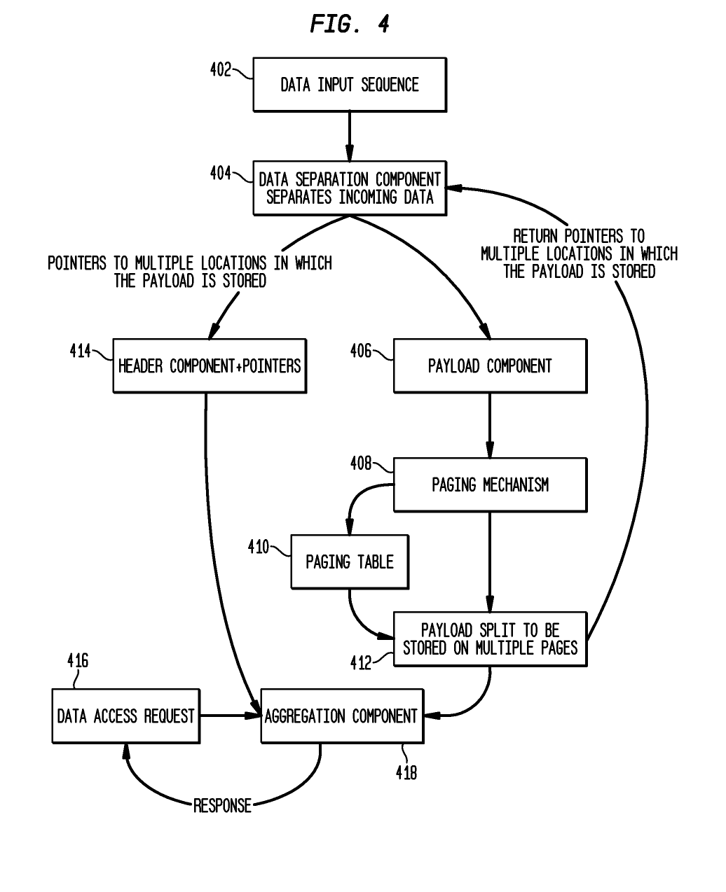

FIG. 4 is a flow diagram depicting at least a portion of an exemplary memory management method 400, according to an embodiment of the invention. The method 400, which may be implemented by a memory management system (e.g., the illustrative memory management system 300 depicted in FIG. 3), is initiated when an input data sequence is received in step 402. As previously stated, in a separation step (module) 404 the input data sequence (e.g., data stream) is preferably analyzed and divided into one or more frames, with each frame comprising a header portion and a corresponding payload data portion. An analysis methodology suitable for use in step 404 may comprise, for example, the recognition of frame boundaries, header information, etc. Once recognized in step 404, the header portion of a given data frame is separated from its corresponding payload data portion. Steps 406 through 412 describe a methodology for processing the payload data portion.

More particularly, in step 406, the payload data portion of a given data frame in the input data sequence, which has been separated from its corresponding header portion, is received for storage in a physical memory space of the system. A paging mechanism is used in step 408 for determining how to allocate the payload data portion to the available storage space in the physical memory. A memory paging mechanism is a virtual memory management scheme in which an operating system retrieves data from the physical memory in same-size blocks (e.g., 4 Kbytes (KB)) called pages. It is to be appreciated that embodiments of the invention are not limited to any specific page block size. An advantage of paging over other memory management schemes, such as, for example, memory segmentation, is that paging allows the physical address space to be noncontiguous (i.e., nonadjacent).

There are various known paging methodologies that are suitable for use with embodiments of the invention. In one embodiment, at least one paging table (or page table) is employed in step 410. A page table is operative to translate virtual addresses utilized by an application into physical addresses used by hardware (e.g., memory management unit (MMU)) to process instructions. Each of at least a subset of entries in the page table holds a flag, or alternative indicator, denoting whether or not the corresponding page resides in physical memory. If the corresponding page is in the physical memory, the page table entry will contain the physical memory address at which the page is stored. When a reference is made to a page by the hardware, if the page table entry for the page indicates that it is not currently in the physical memory, the hardware raises a page fault exception, invoking a paging supervisor component of the operating system.

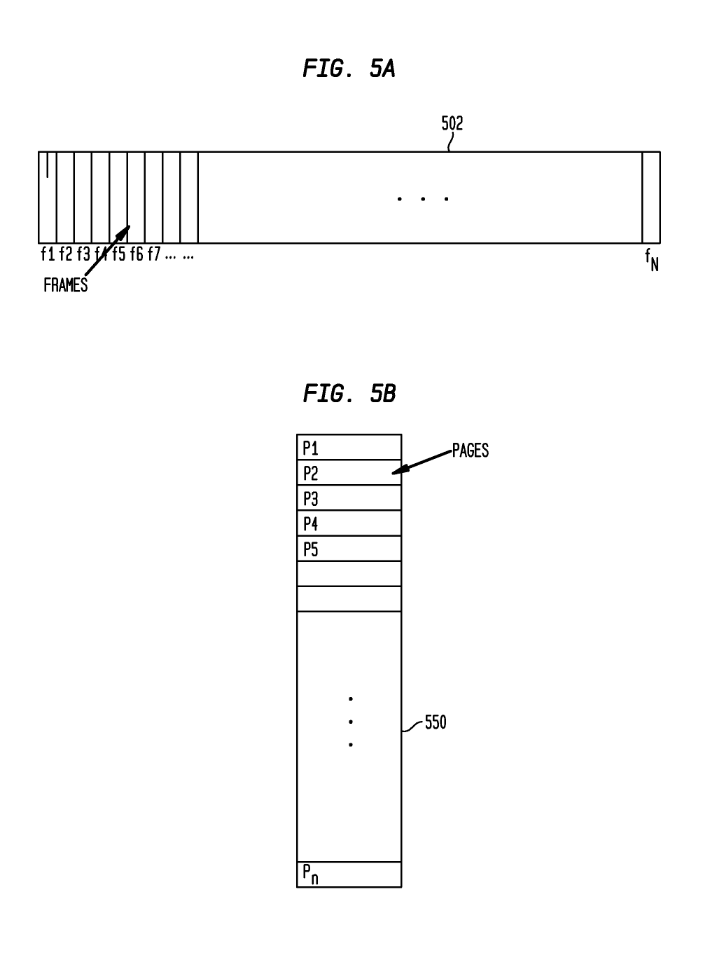

Systems can be configured having a single page table for the whole system, multiple page tables (one for each application and segment), a tree or alternative hierarchy of page tables for large segments, or some combination of one or more of these paging configurations. When only a single page table is used, different applications running concurrently will use different portions of a single range of virtual addresses. When there are multiple page or segment tables, there are multiple virtual address spaces, and concurrent applications with separate page tables will redirect to different physical addresses. An operation of a paging mechanism according to embodiments of the invention will be described in further detail herein below in conjunction with FIGS. 5A through 7.

Using the page table in step 410, the payload data portion is split, based at least in part on a size of the payload data and a size of the page. Thus, if the size of the payload data portion is smaller than the page size, the payload data can be stored in the physical memory without being split into multiple pages. However, when the size of the payload data portion is greater than the page size, the payload data is split into multiple pages in step 412. In this instance, pointers (or an alternative address tracking means) to each of the multiple locations in which the payload data portion is stored are returned to the separation step 404. Advantageously, it is to be understood that the multiple pages of payload data need not be contiguous in the physical storage space, and therefore fragmentation is not a concern using embodiments of the invention.

Referring again to the separation step 404, the header portion associated with the stored payload data of a given data frame is combined with the corresponding pointer(s) to the multiple locations (assuming the payload data is stored on multiple pages) in which the payload data portion is stored generated in step 412. In step 414, the combined header portion and corresponding pointer(s) are maintained in a logical (i.e., virtual) memory space. When a data access request is received in step 416, the request is sent to an aggregation step (module) 418, wherein the combined header portion and associated pointer(s) from step 414 are retrieved and, using the pointers, the corresponding payload data portion is retrieved from the physical storage space indexed by the pointers. The header portion is then combined with the corresponding payload data portion in step 418 and returned as part of the response to the data access request.

With reference now to FIGS. 5A through 7, an illustrative paging mechanism is conceptually described which is suitable for use with embodiments of the invention. More particularly, FIG. 5A conceptually depicts a physical storage space 502 which is divided into a plurality of frames, f1, f2, f3, f4, f5, f6, f7, . . . , f_{N}, where N is an integer. The frames f1 through f_{N} are all equal in size relative to one another and the frame size may vary depending on prescribed memory system requirements (e.g., 4 KB each). It is to be appreciated that the invention is not limited to any specific frame size.

FIG. 5B conceptually depicts a logical storage space (i.e., logical volume) 550 which is divided into a plurality of pages, P1, P2, P3, P4, P5, . . . , Pn, where n is an integer. In this illustrative embodiment, the pages P1 through Pn are all equal in size relative to one another, although in other embodiments, the pages need not be of equal size. The page size is defined as per prescribed memory system requirements and is typically a power of two, varying between about 512 bytes and 16 megabytes (MB), for example. The selection of power of two for the page size facilitates the translation from a logical address into a page number and page offset. Generally, in determining page size, a trade-off exists: a smaller page size results in a larger page table, while a larger page size can result in internal fragmentation. It is to be appreciated, however, that the invention is not limited to any specific page size.

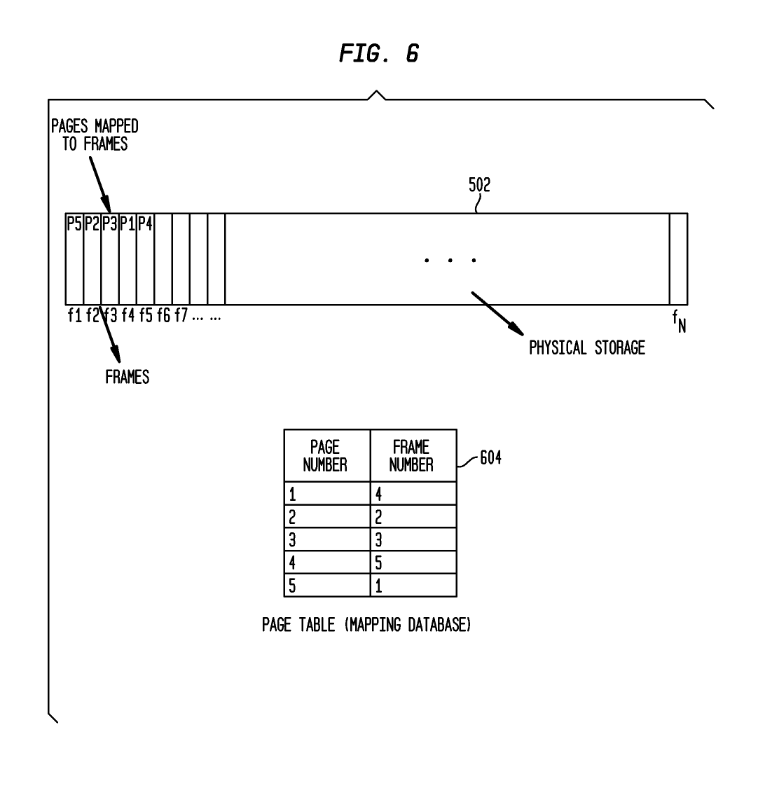

FIG. 6 conceptually depicts an exemplary mapping of pages of a logical storage space to frames of a physical storage space. As previously stated, the physical storage space 502 is divided into a plurality of frames, f1, f2, f3, f4, f5, f6, f7, . . . , f_{N}, where N is an integer. Pages P1 through P5 from the logical storage space 550 shown in FIG. 5B are mapped to corresponding frames of the physical storage space 502. For example, page P1 is mapped to frame f4, page P2 is mapped to frame f2, page P3 is mapped to frame f3, page P4 is mapped to frame f5, and page P5 is mapped to frame f1. In this illustration, each page is preferably sized to be equal to the frame size, although the invention is not limited to this arrangement (e.g., other embodiments may utilize different modes of sizes of pages/frames). A page table 604 is operative to maintain a mapping of the logical requirement (pages) into the physical storage (frames). The page table 604 can thus be implemented using a database of pointers between respective page numbers and corresponding frames numbers. In this manner, as shown in FIG. 6, the pages of the logical space need not be stored contiguously in the frames of the physical storage space 502.

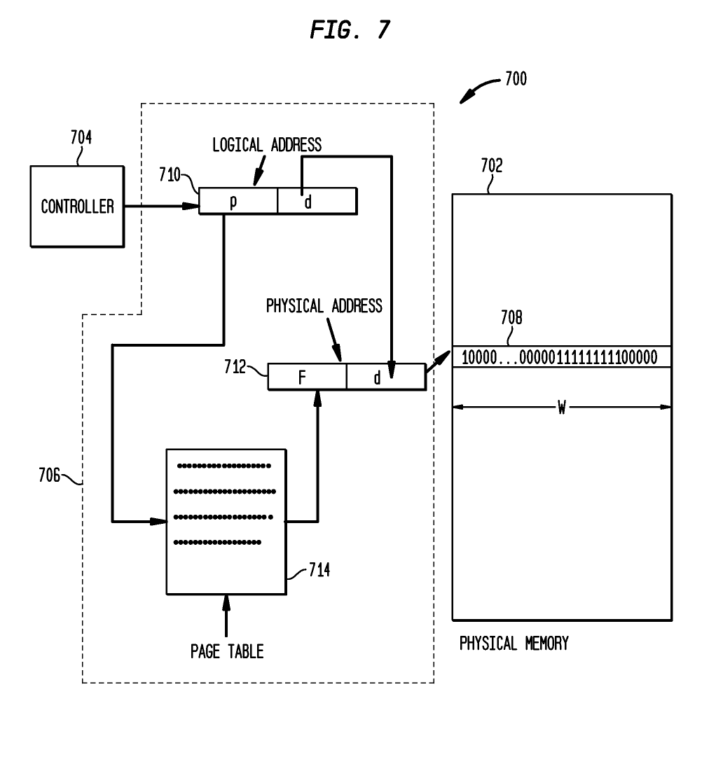

FIG. 7 is a block diagram depicting at least a portion of an exemplary memory management system 700 which conceptually illustrates a paging mechanism suitable for use with embodiments of the invention. The memory management system 700 includes a physical storage space 702, a controller 704, and an address translation module 706 coupled with the physical storage space and controller. The physical storage space 702 is divided into a plurality of frames 708, only one of which is shown for clarity. Each frame is preferably indexed by a unique frame number and has a prescribed bit width, W, associated therewith. The physical storage space 702 is not limited to any particular number of frames or bit width.

The controller 704 is operative to generate logical addresses 710 which are translated by the address translation module 706 into corresponding physical addresses 712 for accessing the physical storage space 702. At least a portion of the physical addresses 712 are generated by a page table 714 as a function of the logical addresses 710. Each logical address 710 generated by the controller 704 is divided into at least two portions; namely, a page number, p, and a page offset, d. A page number p is an index to the page table 714, which includes a base address of each page in the physical storage space 702. Likewise, the physical addresses 712 are divided into at least two portions; namely, a frame number (base address), F, and a frame offset, d. The base address in the page table 714, which corresponds to the page number p in the logical address 710, is combined with the page offset d in the logical address 710 to generate the physical address 712 that is sent to the physical storage space 702. It is to be understood that, although shown as separate functional blocks, at least portions of the address translation module 706 may be incorporated with the controller 704 and/or the physical memory 702.

By way of example only and without loss of generality, consider the illustrative mapping shown in FIG. 6. Using the memory mapping defined in page table 604, page P1 of the logical storage space (e.g., 550 in FIG. 5B) is mapped to frame f4 in the physical storage space 502. Assume a page size of four bytes. Logical address 0 is page 1, offset 0. Indexing into the page table 604, it is evident that page P1 is in frame f4. As previously explained, the physical address (Addr_Phy) corresponding to a given logical address can be determined using the expression:

Addr_Phy=f×s+d,

where f is the frame number indexed by the page number associated with the logical address, s is the page size and d is the page offset. Thus, logical address 0 maps to physical address 16 (i.e., 4×4+0). Beneficially, there is no external fragmentation using this scheme; any free frame in the physical storage space can be allocated to a logical volume that needs it.

By way of illustration only, consider a logical volume size of 72,766 bytes and a page size of 2,048 bytes. Based on the page size and logical volume requirement, 35 pages would be required, with 1,086 bytes remaining (i.e., 72766/2048). The logical volume would be allocated to 36 frames in the physical memory, assuming the physical memory frame size is equal to the logical volume page size, as is typically the case. Thus, in a general sense, if the logical volume requires n pages, then at least n frames need to be available for allocation in the physical memory. It is to be appreciated, however, that the page and frame sizes need not be the same. In other embodiments, such as, for example, where there is a desire to accommodate multiple pages in a frame, or vice versa, page sizes and frame sizes can be different.

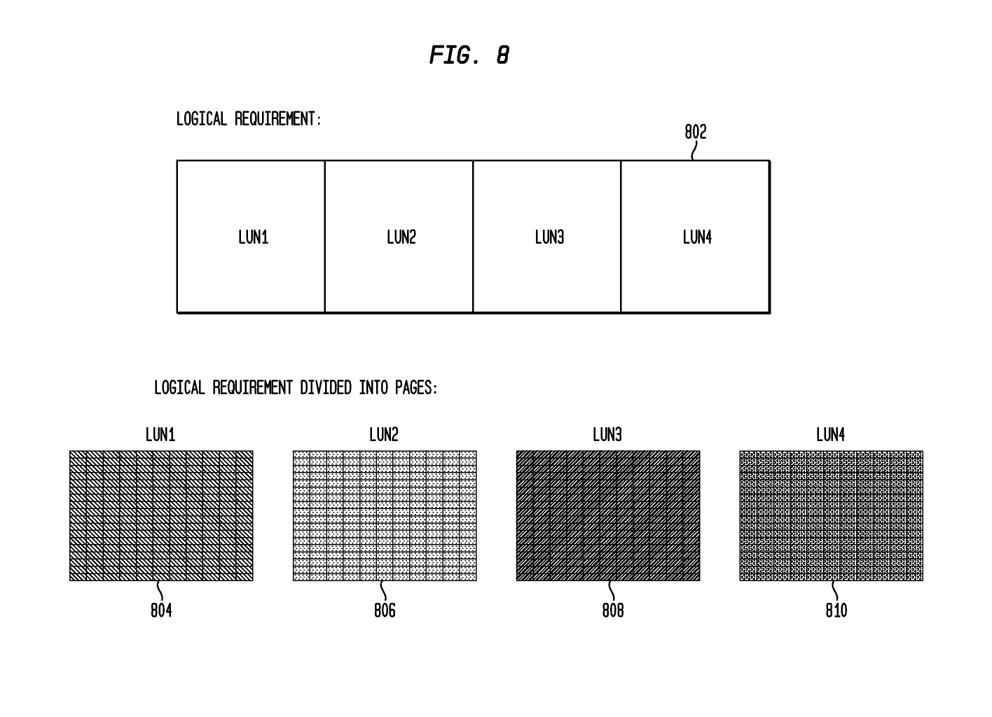

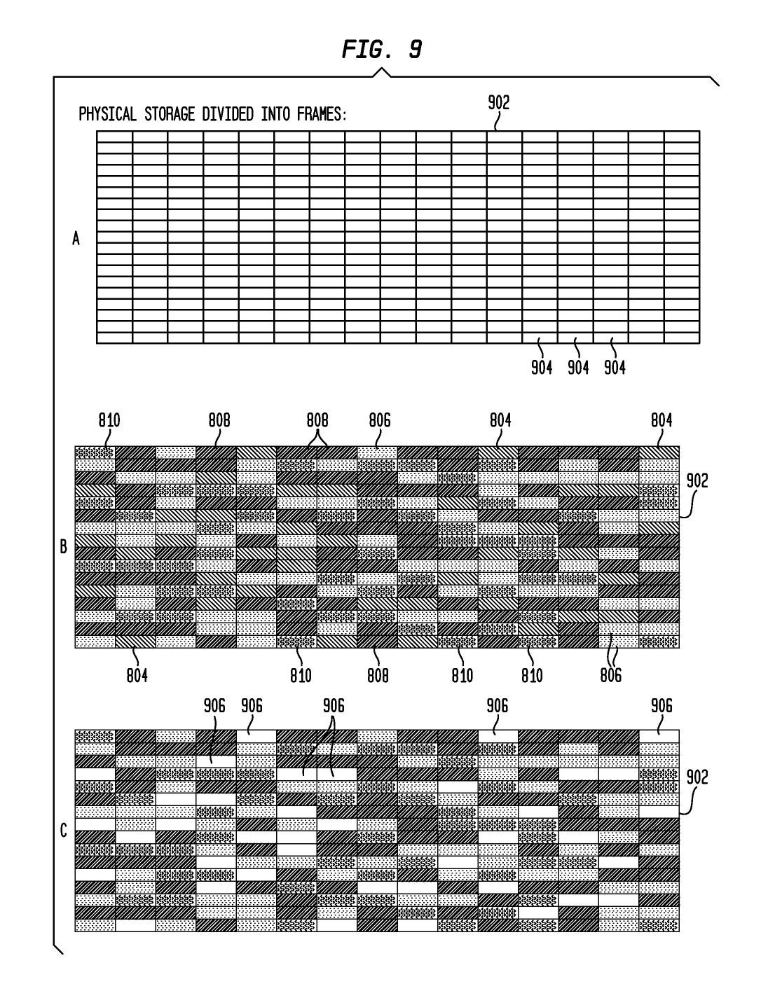

An exemplary mechanism to overcome fragmentation is conceptually depicted in FIGS. 8 and 9A through 9C, according to an embodiment of the invention. As shown in FIG. 8, a logical volume 802 includes four storage requirements, LUN1, LUN2, LUN3 and LUN4. Each of these storage requirements represents the number of bytes of physical storage space required for a given application, task, file, etc. The respective logical requirements LUN1, LUN2, LUN3 and LUN4 are divided into a plurality of corresponding pages 804, 806, 808 and 810, respectively, based on the sizes of the logical requirements and on the page size. It is to be understood that the logical requirements LUN1, LUN2, LUN3, LUN4 may have different sizes relative to one another, and that the invention is not limited to any specific size(s) of the logical requirement(s).

With reference to FIG. 9A, a physical storage space 902 is shown divided into a plurality of equal-size frames 904. Each of the frames 904 is the same size as each of the pages of the logical storage requirement to facilitate mapping between the logical volume 802 and the physical storage space 900. FIG. 9B conceptually illustrates an exemplary mapping of the four logical requirements LUN1 804, LUN2 806, LUN3 808 and LUN4 810, into the frames 904 of the physical storage space 902. Advantageously, as apparent from FIG. 9B, each of the logical requirements need not be stored contiguously in the physical storage space 902.

FIG. 9C illustrates an exemplary result of one of the logical requirements, LUN1 804, being deleted from the physical storage space 902. As shown in FIG. 9C, deleting LUN1 804 results in empty frames 906. These empty frames 906 are available to store one or more other logical requirements as needed. As previously explained, since the logical requirement need not be contiguously stored in the physical storage space 902, embodiments of the invention beneficially overcome external fragmentation and provide a more efficient volume management mechanism. Furthermore, the memory management techniques according to embodiments of the invention easily facilitate expansion of logical volumes by merely occupying additional free frames in the physical storage space 902, without the necessity of moving logical volumes otherwise required using a standard memory management scheme.

In accordance with an embodiment of the invention, a method of controlling the utilization of physical memory resources in a system includes the steps of: receiving an input data sequence comprising one or more data frames; separating each of the one or more data frames in the input data sequence into a payload data portion and a header portion corresponding thereto; storing the payload data portion in at least one available memory location in a physical storage space; and storing in a logical storage space the header portion along with at least one associated index indicative of where in the physical storage space the corresponding payload data portion resides.

As indicated above, embodiments of the invention can employ hardware or hardware and software aspects. Software includes, but is not limited to, firmware, resident software, microcode, etc. One or more embodiments of the invention or elements thereof may be implemented in the form of an article of manufacture including a machine readable medium that contains one or more programs which when executed implement method step(s) according to embodiments of the invention; that is to say, a computer program product including a tangible computer readable recordable storage medium (or multiple such media) with computer usable program code stored thereon in a non-transitory manner for performing the method steps. Furthermore, one or more embodiments of the invention or elements thereof can be implemented in the form of an apparatus including a memory and at least one processor (e.g., memory management unit, memory controller, etc.) that is coupled with the memory and operative to perform, or facilitate the performance of, exemplary method steps.

As used herein, “facilitating” an action includes performing the action, making the action easier, helping to carry out the action, or causing the action to be performed. Thus, by way of example only and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

Yet further, in another aspect, one or more embodiments of the invention or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a tangible computer-readable recordable storage medium (or multiple such media). Appropriate interconnections via bus, network, and the like can also be included.

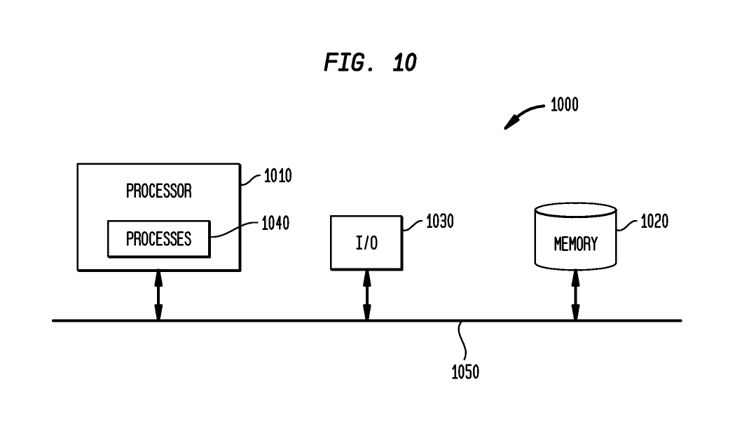

Embodiments of the invention may be particularly well-suited for use in an electronic device or alternative system (e.g., RAID system, network server, etc.). For example, FIG. 10 is a block diagram depicting at least a portion of an exemplary processing system 1000 formed in accordance with an embodiment of the invention. System 1000, which may represent, for example, a RAID system or a portion thereof, may include a processor 1010, memory 1020 coupled with the processor (e.g., via a bus 1050 or alternative connection means), as well as input/output (I/O) circuitry 1030 operative to interface with the processor. The processor 1010 may be configured to perform at least a portion of the functions of the present invention (e.g., by way of one or more processes 1040 which may be stored in memory 1020 and loaded into processor 1010), illustrative embodiments of which are shown in the previous figures and described herein above.

It is to be appreciated that the term “processor” as used herein is intended to include any processing device, such as, for example, one that includes a CPU and/or other processing circuitry (e.g., network processor, microprocessor, digital signal processor, etc.). Additionally, it is to be understood that a processor may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., display, etc.) for presenting the results associated with the processor.

Accordingly, an application program, or software components thereof, including instructions or code for performing the methodologies of the invention, as described herein, may be stored in a non-transitory manner in one or more of the associated storage media (e.g., ROM, fixed or removable storage) and, when ready to be utilized, loaded in whole or in part (e.g., into RAM) and executed by the processor. In any case, it is to be appreciated that at least a portion of the components shown in the previous figures may be implemented in various forms of hardware, software, or combinations thereof (e.g., one or more microprocessors with associated memory, application-specific integrated circuit(s) (ASICs), functional circuitry, one or more operatively programmed general purpose digital computers with associated memory, etc.). Given the teachings of the invention provided herein, one of ordinary skill in the art will be able to contemplate other implementations of the components of the invention.

At least a portion of the techniques of the present invention may be implemented in an integrated circuit. In forming integrated circuits, identical die are typically fabricated in a repeated pattern on a surface of a semiconductor wafer. Each die includes a device described herein, and may include other structures and/or circuits. The individual die are cut or diced from the wafer, then packaged as an integrated circuit. One skilled in the art would know how to dice wafers and package die to produce integrated circuits. Integrated circuits so manufactured are considered part of this invention.

An integrated circuit in accordance with the present invention can be employed in essentially any application and/or electronic system in which data storage devices may be employed. Suitable systems for implementing techniques of the invention may include, but are not limited to, servers, personal computers, data storage networks, etc. Systems incorporating such integrated circuits are considered part of this invention. Given the teachings of the invention provided herein, one of ordinary skill in the art will be able to contemplate other implementations and applications of the techniques of the invention.

The illustrations of embodiments of the invention described herein are intended to provide a general understanding of the architecture of various embodiments of the invention, and they are not intended to serve as a complete description of all the elements and features of apparatus and systems that might make use of the architectures and circuits according to embodiments of the invention described herein. Many other embodiments will become apparent to those skilled in the art given the teachings herein; other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

Embodiments of the inventive subject matter are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The abstract is provided to comply with 37 C.F.R. §1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus the following claims are hereby incorporated into the Detailed Description, with each claim standing on its own as separately claimed subject matter.

Given the teachings of embodiments of the invention provided herein, one of ordinary skill in the art will be able to contemplate other implementations and applications of the techniques of embodiments of the invention. Although illustrative embodiments of the invention have been described herein with reference to the accompanying drawings, it is to be understood that embodiments of the invention are not limited to those precise embodiments, and that various other changes and modifications are made therein by one skilled in the art without departing from the scope of the appended claims.

What is claimed is:

1. A memory management apparatus, comprising:
a first controller adapted to receive an input data sequence comprising one or more data frames, the first controller being operative: (i) to separate each of the one or more data frames in the input data sequence into a payload data portion and a header portion corresponding thereto; (ii) to store the payload data portion in at least one available memory location in a physical storage space; and (iii) to store in a logical storage space the header portion along with at least one associated index indicative of where in the physical storage space the corresponding payload data portion resides; and
at least a second controller operative, as a function of a data read request, to access the physical storage space using the header portion and the associated index from the logical storage space to retrieve the corresponding payload data portion and to combine the header portion with the corresponding payload data portion to generate a response to the data read request.

2. The apparatus of claim 1, wherein the first controller comprises a separation module operative to recognize frame boundaries between adjacent data frames in the input data sequence and to separate the header portion from the corresponding payload data portion for a given one of the data frames.

3. The apparatus of claim 1, wherein the first controller is operative to generate one or more pointers, each of the one or more pointers being indicative of a corresponding frame number of a frame in the physical storage space where at least a portion of the payload data portion is stored, the at least one associated index comprising the one or more pointers.

4. The apparatus of claim 1, wherein the first controller comprises a paging module operative to allocate payload data of a given data frame in the input data sequence to one or more available frames in the physical storage space.

5. The apparatus of claim 4, wherein the paging module is operative to generate a correspondence between the payload data of the given data frame in the input data sequence and the one or more available frames in the physical storage space in which the payload data is stored.

6. The apparatus of claim 5, wherein the paging module comprises a page table operative to generate the correspondence between the payload data and the one or more available frames in the physical storage space in which the payload data is stored.

7. The apparatus of claim 6, wherein each of at least a subset of entries in the page table comprises an indicator denoting whether a corresponding page resides in the physical storage space, and when the corresponding page resides in the physical storage space, the page table entry includes a physical memory address at which the page is stored in the physical storage space.

8. The apparatus of claim 1, wherein the logical storage space is divided into a plurality of equal size pages, and wherein the first controller is operative to split the payload data portion, as a function of a size of the payload data portion and a size of each of the pages, to be stored on multiple pages when the size of the payload data portion is greater than the page size.

9. The apparatus of claim 1, wherein the logical storage space is divided into a plurality of pages, at least a subset of the plurality of pages being unequal in size relative to one another, and wherein the first controller is operative to split the payload data portion, as a function of a size of the payload data portion and a size of each of the pages, to be stored on multiple pages when the size of the payload data portion is greater than the page size.

10. The apparatus of claim 1, wherein the physical storage space comprises a plurality of equal size frames, and wherein the first controller comprises a paging module operative to divide the logical storage space into a plurality of pages, a size of each of the pages of the logical storage space being equal to a frame size of each of the frames in the physical storage space.

11. The apparatus of claim 1, wherein the physical storage space comprises a plurality of frames, at least a subset of the plurality of frames being unequal in size relative to one another, and wherein the first controller comprises a paging module operative to divide the logical storage space into a plurality of pages, a size of each of the pages of the logical storage space being equal to a size of a corresponding frame in the physical storage space.

12. The apparatus of claim 1, wherein the second controller comprises an aggregation module, the aggregation module being operative to combine the header portion with the corresponding payload data portion to generate the response to the data read request.

13. The apparatus of claim 1, wherein the first controller is operative to store the payload data of a given data frame in the input data sequence in a plurality of available frames in the physical storage space, at least a subset of the plurality of available frames being non-contiguous.

14. A method of managing a utilization of physical memory resources in a system, the method comprising steps of:
receiving an input data sequence comprising one or more data frames;
separating each of the one or more data frames in the input data sequence into a payload data portion and a header portion corresponding thereto;
storing the payload data portion in at least one available memory location in a physical storage space; and
storing in a logical storage space the header portion along with at least one associated index indicative of where in the physical storage space the corresponding payload data portion resides.

15. The method of claim 14, further comprising, as a function of a data read request:
accessing the physical storage space using the header portion and the associated index from the logical storage space to retrieve the corresponding payload data portion; and
combining the header portion with the corresponding payload data portion for generating a response to the data read request.

16. The method of claim 14, wherein the step of separating each of the data frames into a payload data portion and a header portion comprises recognizing frame boundaries between adjacent data frames in the input data sequence and separating the header portion from the corresponding payload data portion for at least a given one of the data frames.

17. The method of claim 14, wherein the step of storing the payload data portion in at least one available memory location in the physical storage space comprises generating one or more pointers, each of the one or more pointers being indicative of a corresponding frame number of a frame in the physical storage space where at least a portion of the payload data portion is stored, the at least one associated index comprising the one or more pointers.

18. The method of claim 14, wherein the step of storing the payload data portion in at least one available memory location in the physical storage space comprises generating a correspondence between the payload data of the given data frame in the input data sequence and the one or more available frames in the physical storage space in which the payload data is stored.

19. The method of claim 14, further comprising:
dividing the logical storage space into a plurality of equal size pages; and
splitting the payload data portion, as a function of a size of the payload data portion and a size of each of the pages, to be stored on multiple pages when the size of the payload data portion is greater than the page size.

20. The method of claim 14, further comprising:
dividing the logical storage space into a plurality of pages, at least a subset of the plurality of pages being unequal in size relative to one another; and
splitting the payload data portion, as a function of a size of the payload data portion and a size of each of the pages, to be stored on multiple pages when the size of the payload data portion is greater than the page size.

21. An integrated circuit including at least one memory management apparatus for controlling a utilization of physical memory resources in a system, the at least one memory management apparatus comprising:
a first controller adapted to receive an input data sequence comprising one or more data frames, the first controller being operative: (i) to separate each of the one or more data frames in the input data sequence into a payload data portion and a header portion corresponding thereto; (ii) to store the payload data portion in at least one available memory location in a physical storage space; and (iii) to store in a logical storage space the header portion along with at least one associated index indicative of where in the physical storage space the corresponding payload data portion resides; and
at least a second controller operative, as a function of a data read request, to access the physical storage space using the header portion and the associated index from the logical storage space to retrieve the corresponding payload data portion and to combine the header portion with the corresponding payload data portion to generate a response to the data read request.

22. An electronic system, comprising:
physical memory; and
at least one memory management module coupled with the physical memory, the at least one memory management module comprising:
a first controller adapted to receive an input data sequence comprising one or more data frames, the first controller being operative: (i) to separate each of the one or more data frames in the input data sequence into a payload data portion and a header portion corresponding thereto; (ii) to store the payload data portion in at least one available memory location in the physical memory; and (iii) to store in a logical storage space the header portion along with at least one associated index indicative of where in the physical memory the corresponding payload data portion resides; and
at least a second controller operative, as a function of a data read request, to access the physical memory using the header portion and the associated index from the logical storage space to retrieve the corresponding payload data portion and to combine the header portion with the corresponding payload data portion to generate a response to the data read request.
